(19) United States
(12) Patent Application Publication
(10) Pub. No.: US 2026/0359927 A1
(43) Pub. Date: Nov. 12, 2026

(54) TECHNIQUES FOR FLEXIBLE VECTORIZED LOADING IN GRAPHICS PROCESSING UNITS (GPUS)

(71) Applicant: QUALCOMM Incorporated, San Diego, CA (US)

(72) Inventors: Elina KAMENETSKAYA, Belmont, MA (US); Fei WEI, San Diego, CA (US); Amir MOMENI, Arlington, MA (US)

(21) Appl. No.: 19/203,052

(22) Filed: May 8, 2025

(51) Int. Cl. G06T 1/60; G06T 1/20; G06T 15/00

(52) U.S. Cl. CPC G06T 1/60; G06T 1/20; G06T 15/005

(57) ABSTRACT

Aspects described herein relate to loading vectorized data from a memory into general purpose registers (GPRs) of a graphics processing unit (GPU) using a transposed load. A load instruction for loading multiple data vectors from the memory into multiple GPRs for each of multiple fibers of the GPU can be received, where the load instruction indicates a transposed load. Based on the load instruction indicating the transposed load, and for each data vector of the multiple data vectors, each element of the data vector can be loaded to a GPR of multiple GPRs that is associated with a different one of the multiple fibers.

### FIELD OF THE DISCLOSURE

Aspects of the present disclosure relate generally to graphics processing unit (GPU) instructions, and more particularly, to vectorized loading of data into registers of a GPU.

### DESCRIPTION OF RELATED ART

Graphics processing units (GPUs) support texture instructions for creating, storing, and/or accessing textures in memory, where the GPU can execute instructions for rendering the textures on a display. GPUs can include a texture engine to provide this functionality, and/or can include a load store engine for moving data between memory and registers (e.g., general purpose registers (GPRs)) of the GPU. GPU texture and/or load store engines can support vectorized loads for each execution fiber, where a coordinate of each execution fiber can point to an address including 1 to 4 elements in memory. Thus, the GPU texture and/or load store engine can support vectorized load instructions for loading each of 1, 2, 3, or 4 elements from memory to a register of the GPU. The start of each vectorized load instruction can access a memory location (e.g., a memory address or origin of the load) and the data located at that address is loaded linearly as a vector into the GPR of the fiber that requested the load. For example, for a first fiber, an element from a first memory address is loaded into a first GPR of the first fiber, an element from a next memory address that is adjacent to the first memory address is loaded into a second GPR of the first fiber, etc. For a second fiber, an element from a first offset memory address that is offset from the first memory address is loaded into a first GPR of the second fiber, an element from a second offset memory address that is adjacent to the first offset memory address is loaded into a second GPR of the second fiber, etc., and so on.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for loading vectorized data from a memory into general purpose registers (GPRs) of a graphics processing unit (GPU) is provided that includes one or more processors including the GPU, one or more memories coupled with the one or more processors, and instructions stored in the one or more memories. The instructions are operable, when executed by the one or more processors, to cause the apparatus to receive a load instruction for loading multiple data vectors from the memory into multiple GPRs for each of multiple fibers of the GPU, wherein the load instruction indicates a transposed load, and based on the load instruction indicating the transposed load, load, for each data vector of the multiple data vectors, each element of the data vector to a GPR of multiple GPRs that is associated with a different one of the multiple fibers.

According to another aspect, a computer-implemented method for loading vectorized data from a memory into GPRs of a GPU is provided that includes receiving a load instruction for loading multiple data vectors from the memory into multiple GPRs for each of multiple fibers of the GPU, wherein the load instruction indicates a transposed load, and based on the load instruction indicating the transposed load, loading, for each data vector of the multiple data vectors, each element of the data vector to a GPR of multiple GPRs that is associated with a different one of the multiple fibers.

According to another aspect, a computer-readable medium that includes code executable by one or more processors for loading vectorized data from a memory into GPRs of a GPU is provided. The code includes code for receiving a load instruction for loading multiple data vectors from the memory into multiple GPRs for each of multiple fibers of the GPU, wherein the load instruction indicates a transposed load, and based on the load instruction indicating the transposed load, loading, for each data vector of the multiple data vectors, each element of the data vector to a GPR of multiple GPRs that is associated with a different one of the multiple fibers.

In a further aspect, an apparatus is provided that includes a transceiver, a memory configured to store instructions, and one or more processors communicatively coupled with the transceiver and the memory. The one or more processors are configured to execute the instructions to perform the operations of methods described herein. In another aspect, an apparatus is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects are hereinafter described in conjunction with the appended drawings, provided to illustrate and not to limit the disclosed aspects, wherein like designations denote like elements, and in which:

FIG. 1 is a block diagram that illustrates an example of a content generation system, in accordance with aspects described herein;

FIG. 2 illustrates an example of a graphics processing unit (GPU), in accordance with aspects described herein;

FIG. 3 is a diagram that illustrates processing components, such as a processing unit and system memory, as may be identified in connection with a device for processing data, in accordance with aspects described herein;

FIG. 4 illustrates diagram including one example of GPU hardware, in accordance with aspects described herein;

FIG. 5 is a diagram illustrating another example of a GPU, in accordance with aspects described herein;

FIG. 6 illustrates examples of memory and GPR contents for a vec4 load instruction performed by a GPU, in accordance with aspects described herein;

FIG. 7 illustrates examples of memory and GPR contents for a vec2 load instruction performed by a GPU, in accordance with aspects described herein; and

FIG. 8 illustrates a flow chart of an example of a method for performing a transposed vectorized load of data into registers of a GPU, in accordance with aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to providing flexible vectorized loads for graphics processing units (GPUs), which can decouple the source memory layout from the destination register layout. For example, an additional or alternative vectorized load instruction can be provided or supported for loading data from memory associated with a GPU into registers (e.g., general purpose registers (GPRs)) of the GPU with an alternative order than that currently supported, such as using a transposed load or load order. For example, an element from a first memory address can be loaded into a first GPR of the first fiber, an element from a next memory address that is adjacent to the first memory address can be loaded into a first GPR of the second fiber, etc. In this example, an element from a first offset memory address that is offset from the first memory address can be loaded into a second GPR of the first fiber, an element from a second offset memory address that is adjacent to the first offset memory address can be loaded into a second GPR of the second fiber, etc., and so on. The texture engine and/or the load store engine can support the alternative loading, such as by supporting an alternative load instruction, a parameter in a load instruction that can be set to indicate conventional loading or transpose loading, etc.

The transposed load may otherwise be achieved by using scalar data loading (e.g., single vector loading, or vec1) for each fiber. In this example, each fiber can indicate the exact address of the single value it loads, therefore decoupling the GPR layout from the memory structure. The scalar load, however, may require four times more coordinate calculations to load the same amount of data and/or four times more load instructions to be issued. The scalar load may achieve only a quarter of the vectorized load bus capacity since only one element is loaded per fiber and adjacent fibers are accessing non-adjacent addresses in memory. In another example, the conventional vectorized load can be used to initially generate the existing linear layout in GPR. Once data is loaded, shuffle instructions can be provided to an application programing interface (API) of the GPU to move data between fibers to produce the transposed GPR layout. These instructions incur overhead in execution time and GPR footprint for intermediate GPR data storage (temporary duplication), and may create redundant data movement for the localized shuffling as data is transported from a GPR of one fiber to another.

In accordance with aspects described herein, for example, the benefits of having a vectorized load instruction (and/or store instructions) that supports transposed load can include efficient data coalescing without incurring performance penalty for data movement across fiber boundaries while writing to GPR, as the data transpose can be accomplished by the texture and/or load store engine at the time of data arrival from memory. As such, the load instruction can be extended to encode a new option to indicate the command to transpose the destination values as they are written into GPR storage. In an example, a compiler of the GPU can generate the load instruction to indicate performing the transposed load in an optimization process during compilation. For example, the compiler can detect, based on other compiled instructions, that a transposed load may be more efficient than a conventional load, and may accordingly select the transpose load instruction (or transpose option for the load instruction) during the compilation process. The compiler can similarly support a transposed store for storing data loaded with transpose back to memory.

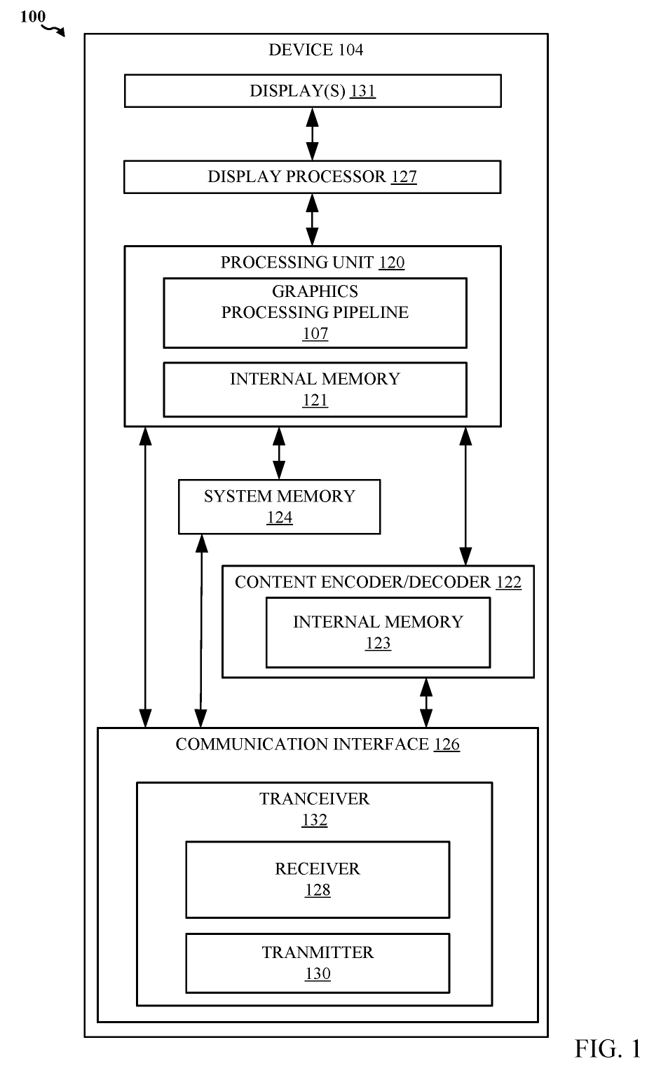

The described features are presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features are presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

FIG. 1 is a block diagram that illustrates an example of a content generation system 100, in accordance with aspects described herein. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context is processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

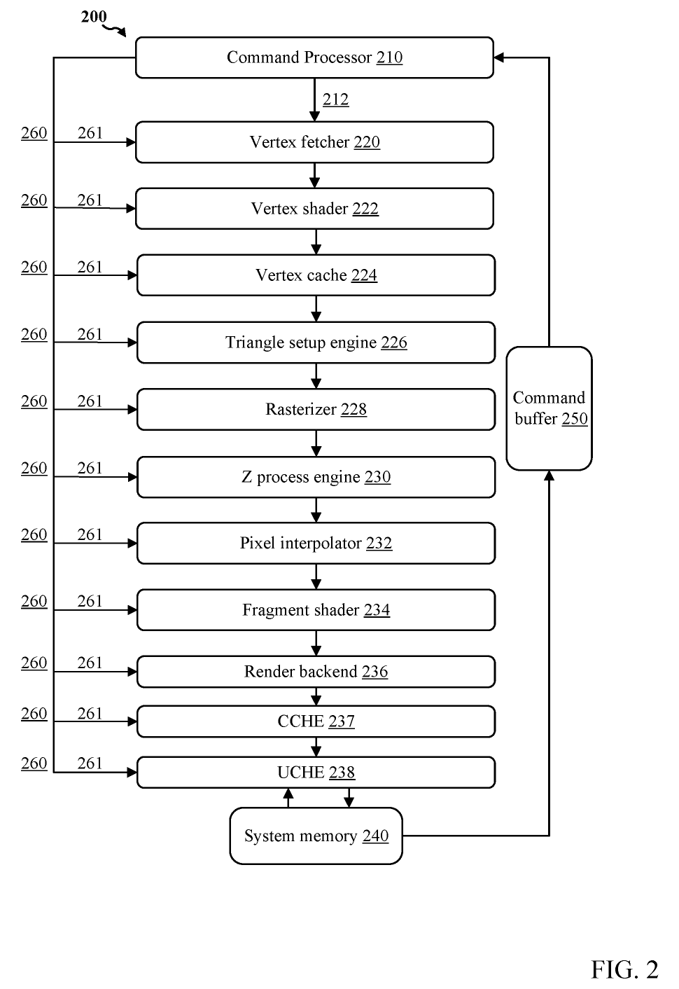

FIG. 2 illustrates an example of a GPU 200, in accordance with aspects described herein. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

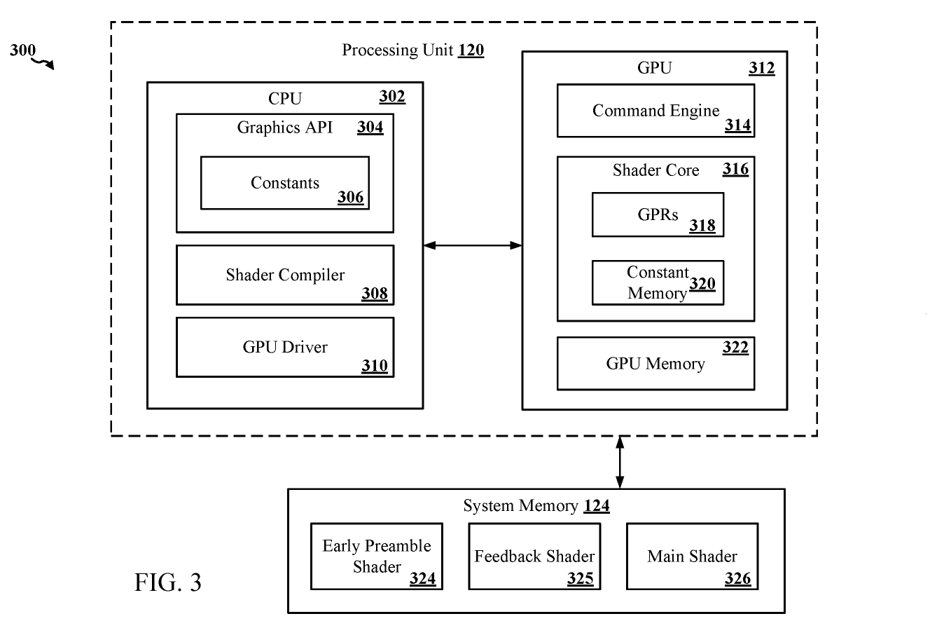

FIG. 3 is a diagram 300 that illustrates processing components, such as the processing unit 120 and the system memory 124, as may be identified in connection with the device 104 for processing data, in accordance with aspects described herein. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 is described in further detail below.

The shader core 316 included in the GPU 312 may include general purpose registers (GPRs) 318 and/or constant memory 320. The GPRs 318 may correspond to a single GPR, a GPR file, and/or a GPR bank. Each GPR in the GPRs 318 may store data accessible to a single thread/fiber. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, shader compiler 308 can compile shader code for executing instructions to generate textures or other graphical features via the GPU 312. In an example, the shader compiler 308 can support load instructions for loading data from memory, such as system memory 124, GPU memory 322, etc. into one or more GPRs 318, store instructions for storing data from one or more GPRs 318 to memory, and/or the like. In one example, shader compiler 308 can support a load instruction for performing a transposed load of data from memory into GPRs 318, as described herein. The transposed load instruction can include a specific instruction for transposed loading, a general load instruction with a parameter for specifying transposed loading (e.g., or conventional loading), and/or the like. In an example, shader compiler 308 can select a transposed or conventional load based on determining which load is more efficient for subsequent operations from the code being compiled. In addition, in an example, shader compiler 308 can select a transposed or conventional store for storing loaded data from GPRs 318 back to memory (e.g., system memory 124, GPU memory 322, etc.) based on whether the data is loaded conventionally or with transpose.

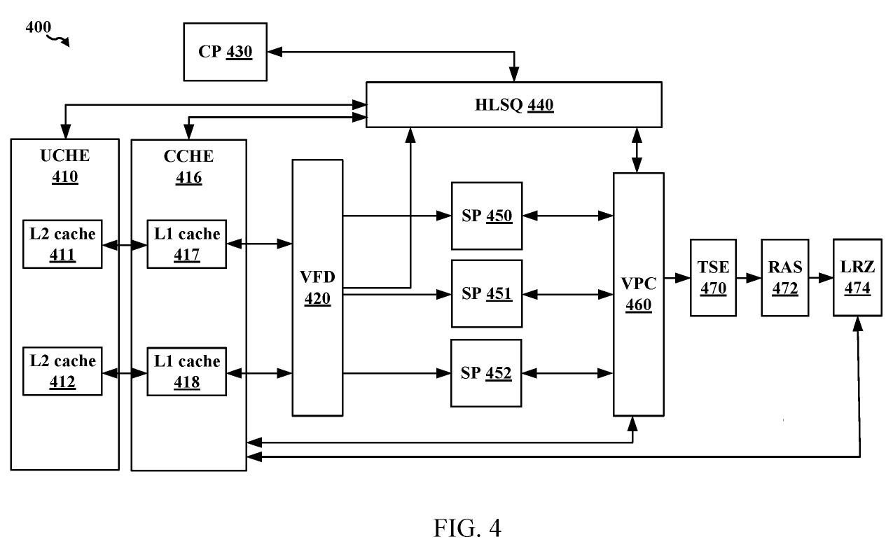

FIG. 4 is a diagram illustrating another example of a GPU, in accordance with aspects described herein. More specifically, FIG. 4 depicts GPU 400 including a number of different components. As shown in FIG. 4, GPU 400 includes UCHE 410 including L2 cache 411 and L2 cache 412, CCHE 416 including L1 cache 417 and L1 cache 418, VFD 420, CP 430, high level sequencer (HLSQ) 440, a number of shader processors (e.g., shader processor 450, shader processor 451, and shader processor 452), VPC 460, TSE 470, RAS 472, and low resolution Z (LRZ) component (e.g., LRZ 474). As shown in FIG. 4, CP 430 may transmit data to HLSQ 440 and receive data from HLSQ 440. CCHE 416 may transmit/receive data to/from HLSQ 440. UCHE 410 may also transmit/receive data to/from HLSQ 440. L2 cache 411 and L2 cache 412 may transmit/receive data to/from VFD 420. Further, VFD 420 may transmit data to HLSQ 440, as well as transmit data to shader processors 450-452. Moreover, shader processors 450-452 may transmit/receive data to/from VPC 460. Also, VPC 460 may transmit/receive data to/from HLSQ 440. Data can also be transmitted from VPC 460 to TSE 470, which can transmit data to RAS 472, and then to LRZ 474. CCHE 416 can transmit/receive data to/from VPC 460 and LRZ 474. Also, UCHE 410 can transmit/receive data to/from VPC 460 and LRZ 474.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

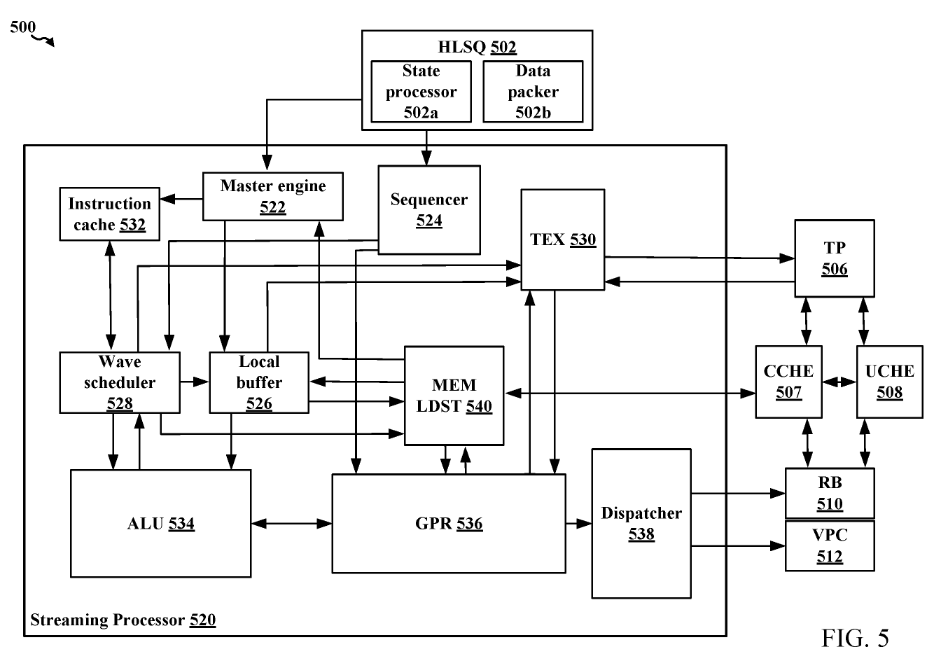

FIG. 5 illustrates an example of a GPU 500, in accordance with aspects described herein. Specifically, FIG. 5 illustrates a streaming processor or shader processor 520 system in GPU 500. As shown in FIG. 5, GPU 500 includes a HLSQ 502, texture processor (TP) 506, L1 CCHE 507, L2 UCHE 508, RB 510, and VPC 512. GPU 500 also includes streaming processor 520, master engine 522, sequencer 524, local buffer 526, wave scheduler 528, texture (TEX) engine 530, instruction cache 532, arithmetic logic unit (ALU) 534, GPR 536, dispatcher 538, and memory (MEM) load store (LDST) engine 540. In some aspects, streaming processor 520 may be referred to as a shader processor.

As shown in FIG. 5, each unit or block in GPU 500 may send data or information to other blocks. For instance, HLSQ 502 may send commands to the master engine 522. Also, HLSQ 502 may send vertex threads, vertex attributes, pixel threads, pixel attributes, and/or compute commands to the sequencer 524. TP 506 may receive texture requests from TEX 530, and send texture elements (texels) back to the TEX 530. Further, TP 506 may send memory read requests to and receive memory data from CCHE 507 or UCHE 508. CCHE 507 or UCHE 508 may also receive memory read or write requests from MEM LDST 540 and send memory data back to MEM LDST 540, as well as receive memory read or write requests from RB 510 and send memory data back to RB 510. Also, RB 510 may receive an output in the form of color from GPR 536, e.g., via dispatcher 538. VPC 512 may also receive output in the form of vertices from GPR 536, e.g., via dispatcher 538. GPR 536 may send address data or receive write back data from MEM LDST 540. GPR 536 may also send temporary data to and receive temporary data from ALU 534. Moreover, ALU 534 may send address or predicate information to the wave scheduler 528, as well as receive instructions from wave scheduler 528. Local buffer 526 may send constant data to ALU 534. TEX 530 may also receive texture attributes from or send texture data to GPR 536, as well as receive constant data from local buffer 526. Further, TEX 530 may receive texture requests from wave scheduler 528, as well as receive constant data from local buffer 526. MEM LDST 540 may send/receive constant data to/from local buffer 526. Sequencer 524 may send wave data to wave scheduler 528, as well as send data to GPR 536. The sequencer 524 may allocate resources and local memory. Also, the sequencer 524 may allocate wave slots and any associated GPR 536 space. For example, the sequencer 524 may allocate wave slots or GPR 536 space when the HLSQ 502 issues a pixel tile workload to the streaming processor 520. Master engine 522 may send program data to instruction cache 532, as well as send constant data to local buffer 526 and receive instructions from MEM LDST 540. Instruction cache 532 may send instructions or decode information to wave scheduler 528. Wave scheduler 528 may send read requests to local buffer 526, as well as send memory requests to MEM LDST 540.

As further shown in FIG. 5, the HLSQ 502 may prepare one or more context states for the streaming processor 520. For example, the HLSQ 502 may prepare the context states for different types of data, e.g., global register data, shader constant data, buffer descriptors, instructions, etc. Additionally, the HLSQ 502 may embed context states into a command stream to the streaming processor 520. The master engine 522 may parse the command stream from the HLSQ 502 and setup a streaming processor global state. Moreover, the master engine 522 may fill or add to an instruction cache 532 and/or a local buffer 526 or a constant buffer. In some aspects, inside the HLSQ 502, there may be an internal function unit called a state processor 502a. The state processor 502a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 502 may execute the preamble shader and, as a result, skip utilizing a main shader. In some instances, the main shader may perform different shading tasks, such as normal vertex shading and/or a fragment shading program. Moreover, the HLSQ 502 may include a data packer 502b.

Additionally, as shown in FIG. 5, the streaming processor 520 may not be limited to executing a preamble if the HLSQ 502 decides to skip a preamble execution. For instance, the streaming processor 520 may also process a conventional graphics workload, such as vertex shading and/or fragment shading. In some aspects, the streaming processor 520 may utilize its execution units and storage in order to process compute tasks as a general purpose GPU (GPGPU). Inside the streaming processor 520, there may be multiple parallel instruction execution units such as an ALU, elementary function unit (EFU), branching unit, TEX, general memory read and write (aka LDST), etc. The streaming processor 520 may also include on-chip storage memory, such as a GPR 536 which may store per-fiber private data. Also, the streaming processor 520 may include a local buffer 526 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 5, dispatcher 538 may fetch data from GPR 536. Dispatcher 538 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in a streaming processor context register may be utilized to define the GPR identifier (ID) which stores RT data.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LDST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization / pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

In an example, the TEX engine 530 and/or MEM LDST engine 540 can support vectorized load instructions for each execution fiber, where a coordinate of each fiber points to an address that includes one to four elements in memory, such as a vec1 load instruction to load one element, a vec2 load instruction to load two elements, a vec3 load instruction to load three elements, and/or a vec4 load instruction to load four elements. In some examples, additional vectorized load instructions can be supported to load additional elements from memory for a fiber (e.g., into a GPR associated with the fiber). In an example, the TEX engine 530 and/or MEM LDST engine 540 can support a conventional vectorized load instruction where the start of each vector accesses a memory location (address or origin of the load) and the data located at that address is loaded linearly as a vector into the GPR of the fiber that requested the load.

In accordance with aspects described herein, the TEX engine 530 and/or MEM LDST engine 540 can also support a transposed vectorized load instruction where the fibers can swap data elements to generate the transposed data load, and transposed vectorized store instruction where the fibers can swap data elements when storing back to memory, etc. For example, data located at a starting address can be loaded into a GPR of a first fiber, and data located at the next address can be loaded into a GPR of a second fiber.

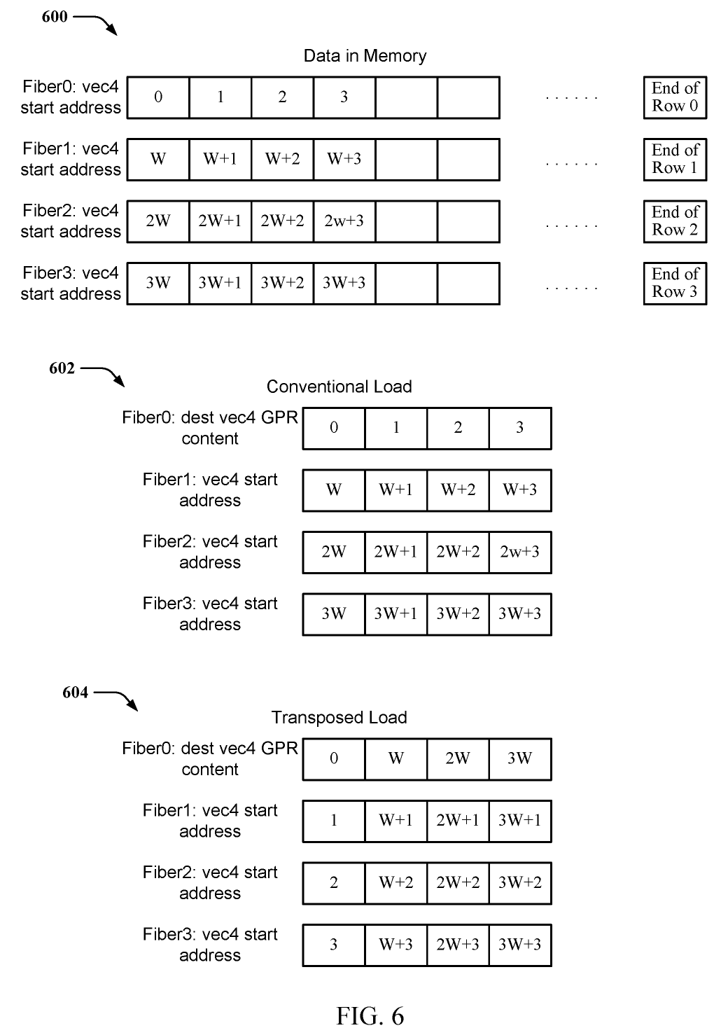

FIG. 6 illustrates examples of memory and GPR contents for a vec4 load instruction performed by a GPU (e.g., by a texture engine, load store engine, etc. of a GPU), in accordance with aspects described herein. For example, the data as stored in memory is shown at 600. Each fiber has a starting address in memory where a number (e.g., 4 for vec4) of data units of a certain size are read for storing in GPRs associated with the fiber. In an example, the vec4 load instruction can specify the starting memory address for each fiber. For example, fiber0 has a starting address for data element 0, fiber1 has a starting address for data element W, fiber2 has a starting address for data element 2W, and fiber3 has a starting address for data element 3W, where W can represent a memory row size or other offset between the starting address between fibers having an adjacent index.

At 602, a conventional vectorized load performed by a GPU is shown, with a correlation between the layout of the source data in memory and the contents of GPRs for each fiber. In the conventional vectorized load, the linear vectorized view of the data in memory is replicated in GPRs of each fiber. For example, the first data element at the starting address of the vec4 instruction for fiber0 (0) is loaded into a first GPR associated with fiber0, the second data element from the starting address of the vec4 instruction for fiber0 (1) is loaded into a second GPR associated with fiber0, the third data element from the starting address of the vec4 instruction for fiber0 (2) is loaded into a third GPR associated with fiber0, and the fourth data element from the starting address of the vec4 instruction for fiber0 (3) is loaded into a fourth GPR associated with fiber0. In this example, the first data element at the starting address of the vec4 instruction for fiber1 (W) is loaded into a first GPR associated with fiber1, the second data element from the starting address of the vec4 instruction for fiber1 (W+1) is loaded into a second GPR associated with fiber1, the third data element from the starting address of the vec4 instruction for fiber1 (W+2) is loaded into a third GPR associated with fiber1, and the fourth data element from the starting address of the vec4 instruction for fiber1 (W+3) is loaded into a fourth GPR associated with fiber1, and so on.

At 604, a transposed vectorized load performed by a GPU is shown, where the linear vectorized view of the data in memory can be decoupled from the layout in the GPR of each fiber. In the transposed vectorized load, for example, the first data element at the starting address of the vec4 instruction for fiber0 (0) is loaded into a first GPR associated with fiber0, the first data element at the starting address of the vec4 instruction for fiber1 (W) is loaded into a second GPR associated with fiber0, the first data element at the starting address of the vec4 instruction for fiber2 (2W) is loaded into a third GPR associated with fiber0, and the first data element at the starting address of the vec4 instruction for fiber3 (3W) is loaded into a fourth GPR associated with fiber0. In this example, the second data element from the starting address of the vec4 instruction for fiber0 (1) is loaded into a first GPR associated with fiber1, the second data element from the starting address of the vec4 instruction for fiber1 (W+1) is loaded into a second GPR associated with fiber1, the second data element from the starting address of the vec4 instruction for fiber2 (2W+1) is loaded into a third GPR associated with fiber1, and the second data element from the starting address of the vec4 instruction for fiber3 (3W+1) is loaded into a fourth GPR associated with fiber1, and so on.

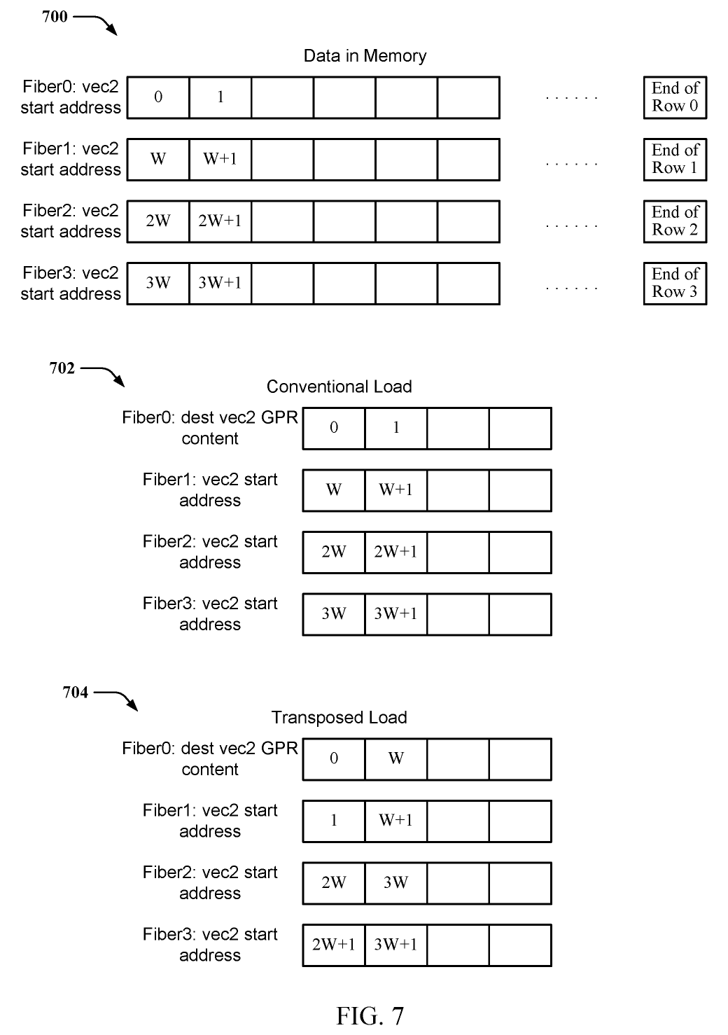

FIG. 7 illustrates examples of memory and GPR contents for a vec2 load instruction performed by a GPU (e.g., by a texture engine, load store engine, etc. of a GPU), in accordance with aspects described herein. For example, the data as stored in memory is shown at 700. Each fiber has a starting address in memory where a number (e.g., 2 for vec2) of data units of a certain size are read for storing in GPRs associated with the fiber. In an example, the vec2 load instruction can specify the starting memory address for each fiber. For example, fiber0 has a starting address for data element 0, and fiber1 has a starting address for data element W. For a vec2 load, two fibers can participate in the swapping of data elements to generate the transposed data load.

At 702, a conventional vectorized load performed by a GPU is shown, with a correlation between the layout of the source data in memory and the contents of GPRs for each fiber. In the conventional vectorized load, the linear vectorized view of the data in memory is replicated in GPRs of each fiber. For example, the first data element at the starting address of the vec2 instruction for fiber0 (0) is loaded into a first GPR associated with fiber0, the second data element from the starting address of the vec2 instruction for fiber0 (1) is loaded into a second GPR associated with fiber0. In this example, the first data element at the starting address of the vec2 instruction for fiber1 (W) is loaded into a first GPR associated with fiber1, the second data element from the starting address of the vec2 instruction for fiber1 (W+1) is loaded into a second GPR associated with fiber1. In this example, the first data element at the starting address of the vec2 instruction for fiber2 (2W) is loaded into a first GPR associated with fiber2, the second data element from the starting address of the vec2 instruction for fiber2 (2W+1) is loaded into a second GPR associated with fiber2. In this example, the first data element at the starting address of the vec2 instruction for fiber3 (3W) is loaded into a first GPR associated with fiber3, the second data element from the starting address of the vec2 instruction for fiber3 (3W+1) is loaded into a second GPR associated with fiber3.

At 704, a transposed vectorized load performed by a GPU is shown, where the linear vectorized view of the data in memory can be decoupled from the layout in the GPR of each fiber. In the transposed vectorized load, for example, the first data element at the starting address of the vec2 instruction for fiber0 (0) is loaded into a first GPR associated with fiber0, the first data element at the starting address of the vec2 instruction for fiber1 (W) is loaded into a second GPR associated with fiber0. In this example, the second data element from the starting address of the vec2 instruction for fiber0 (1) is loaded into a first GPR associated with fiber1, the second data element from the starting address of the vec2 instruction for fiber1 (W+1) is loaded into a second GPR associated with fiber1. In this example, the first data element at the starting address of the vec2 instruction for fiber2 (2W) is loaded into a first GPR associated with fiber2, and the first data element at the starting address of the vec2 instruction for fiber3 (3W) is loaded into a second GPR associated with fiber2. In this example, the second data element from the starting address of the vec2 instruction for fiber2 (2W+1) is loaded into a first GPR associated with fiber3, and the second data element at the starting address of the vec2 instruction for fiber3 (3W+1) is loaded into a second GPR associated with fiber3.

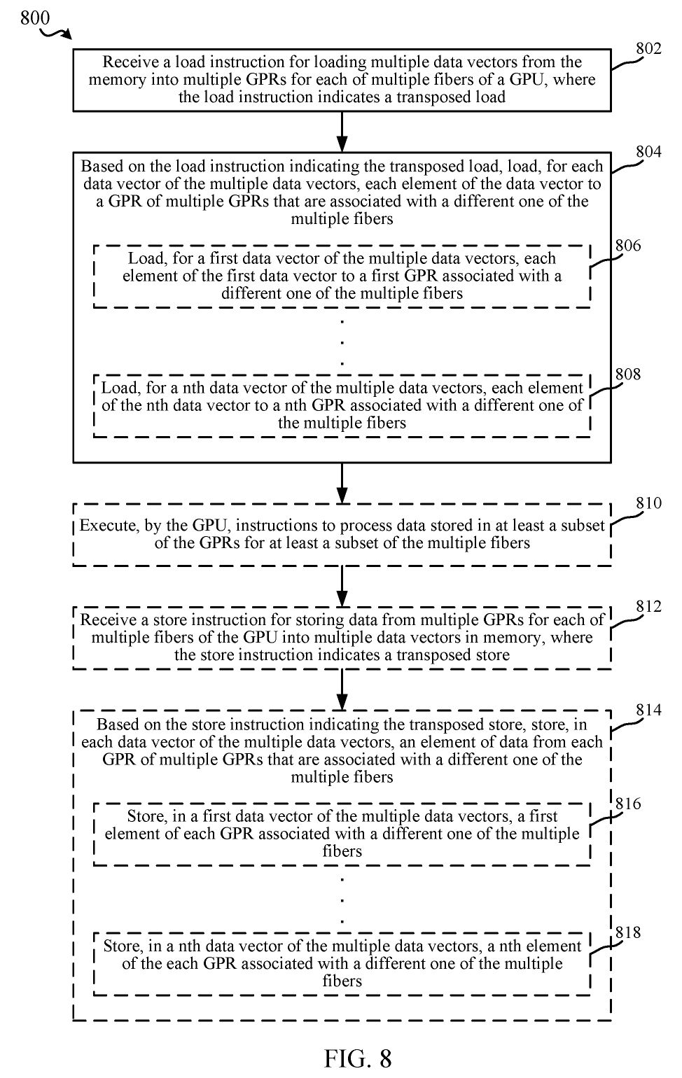

FIG. 8 illustrates a flow chart of an example of a method 800 for performing a transposed vectorized load of data into registers of a GPU, in accordance with aspects described herein. In an example, a processing unit 120, GPU 312, GPU memory 322, shader core 316, streaming processor(s) 450, 451, 452, 520, etc. can perform the functions described in method 800 shown in FIG. 8 using one or more of the components described in FIGS. 1-5.

In method 800, at Block 802, a load instruction for loading multiple data vectors from the memory into multiple GPRs for each of the multiple fibers of a GPU can be received, where the load instruction indicates a transposed load. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can receive the load instruction for loading multiple data vectors from the memory into multiple GPRs for each of the multiple fibers of a GPU, where the load instruction indicates a transposed load. For example, TEX engine 530, MEM LDST engine 540, etc. can receive the load instruction in compiled shader code. In an example, as described, one or more processors, such as a CPU 302, GPU 312, streaming processor(s) 450, 451, 452, 520, thereof, etc., can include a shader compiler 308, which can generate compiled shader code from source code, and the shader compiler 308 can use the load instruction indicating the transposed load, or a load instruction not indicating a transposed load, in certain scenarios where the shader compiler 308 determines the optimal load instruction for a given context.

As described, the TEX engine 530, MEM LDST engine 540, etc. can support one or more load instructions, which may include a load instruction that allows indicating a transposed load. For example, TEX engine 530, MEM LDST engine 540 may support separate sets of instructions for conventional loads and transposed loads for loading different numbers of elements, or may support a single set of instructions for loading different numbers of elements, where the single set of instructions may allow setting of a parameter indicating a type of load (e.g., conventional or transposed load). In any case, as described, the shader compiler 308 can determine to use the transposed load in generating compiled shader code. TEX engine 530, MEM LDST engine 540, etc. can receive the load instruction in the compiled shader code when executing the compiled shader code.

In method 800, at Block 804, based on the load instruction indicating the transposed load, each element of the data vector can be loaded, for each data vector of the multiple data vectors, to a GPR of multiple GPRs that are associated with a different one of the multiple fibers. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can, based on the load instruction indicating the transposed load, load, for each data vector of the multiple data vectors, each element of the data vector to a GPR of multiple GPRs that are associated with a different one of the multiple fibers. For example, the data vector can include or otherwise represent adjacent locations in memory, starting at a starting address of the data vector, that correspond to the data vector of the data vector size. As described, rather than loading each data vector in registers associated with the same fiber, in a transposed load, a data vector can be split such that elements thereof are loaded into registers associated with different fibers (e.g., as shown at 604 in FIG. 6 and at 704 in FIG. 7). The transposed loading format may be desirable for some compiled shader code contexts, such as matrix multiplication operations, convolution operations, etc.

In one example, loading the data vector at Block 804 may optionally include, at Block 806, loading for a first data vector of the multiple data vectors, each element of the first data vector to a first GPR associated with a different one of the multiple fibers, and/or at Block 808, loading for a nth data vector of the multiple data vectors, each element of the first data vector to a nth GPR associated with a different one of the multiple fibers. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can load, for the first data vector of the multiple data vectors, each element of the first data vector to a first GPR associated with a different one of the multiple fibers and/or can load, for the nth data vector of the multiple data vectors, each element of the nth data vector to a first GPR associated with a different one of the multiple fibers. For example, n can be a positive integer, and TEX engine 530, MEM LDST engine 540, etc. can load each element of each data vector from 1 to n, into a corresponding first to nth GPR of each of multiple fibers. For example, TEX engine 530, MEM LDST engine 540 can load the elements of a data vector into GPRs associated with different fibers, as shown and described at 604 in FIG. 6 and at 704 in FIG. 7. In an example, TEX engine 530, MEM LDST engine 540 can load the elements of the data vectors including loading each element of each data vector such that each GPR with a common GPR index for each fiber of the multiple fibers includes one of the elements of a given one of the multiple data vectors.

In method 800, optionally at Block 810, instructions to process data stored in at least a subset of the GPRs can be executed, by the GPU, for at least a subset of the multiple fibers. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can execute the instructions to process data stored in at least the subset of the GPRs for at least the subset of the multiple fibers. For example, as described, the shader processor, or streaming processor(s) 450, 451, 452, 520, etc., can execute, at each fiber, instructions from compiled shader code that may operate on the data stored in the registers to compute and/or output values, which may then be stored from the GPRs to memory. Similar operations can be applied for store instruction that indicates a transposed store for storing data loaded in the GPRs with transpose.

In method 800, optionally at Block 812, a store instruction for storing data from multiple GPRs for each of multiple fibers of the GPU into multiple data vectors in memory can be received, where the store instruction indicates a transposed store. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can receive the store instruction for storing data from multiple GPRs for each of multiple fibers of the GPU into multiple data vectors in memory, where the store instruction indicates a transposed store. For example, TEX engine 530, MEM LDST engine 540, etc. can receive the store instruction in compiled shader code (e.g., where the data to be stored was loaded from memory using transposed load). In an example, as described, one or more processors, such as a CPU 302, GPU 312, streaming processor(s) 450, 451, 452, 520, thereof, etc., can include a shader compiler 308, which can generate compiled shader code from source code, and the shader compiler 308 can use the store instruction indicating the transposed store, or a store instruction not indicating a transposed store, in certain scenarios where the shader compiler 308 determines the optimal store instruction for a given context.

As described, the TEX engine 530, MEM LDST engine 540, etc. can support one or more store instructions, which may include a store instruction that allows indicating a transposed store. For example, TEX engine 530, MEM LDST engine 540 may support separate sets of instructions for conventional store and transposed store for storing different numbers of elements, or may support a single set of instructions for storing different numbers of elements, where the single set of instructions may allow setting of a parameter indicating a type of store (e.g., conventional or transposed store). In any case, as described, the shader compiler 308 can determine to use the transposed store in generating compiled shader code. TEX engine 530, MEM LDST engine 540, etc. can receive the store instruction in the compiled shader code when executing the compiled shader code.

In method 800, optionally at Block 814, based on the store instruction indicating the transposed store, an element of data from each GPR of multiple GPRs that are associated with a different one of the multiple fibers can be stored in each data vector of the multiple data vectors. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can, based on the store instruction indicating the transposed store, store, in each data vector of the multiple data vectors, an element of data from each GPR of multiple GPRs that are associated with a different one of the multiple fibers. For example, the data vector can include or otherwise represent adjacent locations in memory, starting at a starting address of the data vector, that correspond to the data vector of the data vector size. As described, rather than storing data from the registers associated with a given fiber in a data vector, in a transposed store, the data elements in a register of a given fiber can be split among the data vectors stored in memory.

In one example, storing the data vector at Block 814 may optionally include, at Block 816, storing, in a first data vector of the multiple data vectors, a first element of the first each GPR associated with a different one of the multiple fibers, and/or at Block 818, storing, in an nth data vector of the multiple data vectors, an nth element of each GPR associated with a different one of the multiple fibers. In an aspect, TEX engine 530, MEM LDST engine 540, or other components of GPU, e.g., in conjunction with processing unit 120, GPU 312, GPU memory 322, shader core 316, streaming processor(s) 450, 451, 452, 520, etc., can store, in a first data vector of the multiple data vectors, a first element of each GPR associated with a different one of the multiple fibers and/or can store, in the nth data vector of the multiple data vectors, the nth element of each GPR associated with a different one of the multiple fibers. For example, n can be a positive integer, and TEX engine 530, MEM LDST engine 540, etc. can store each first element of each GPR into a first data vector (e.g., sequentially, such that the first element in the first data vector is from a first GRP, a second element in the first data vector is from a second GPR, etc.), each second element of each GPR into a second data vector, and so on until storing each nth element of each GPR into a nth data vector.

The following aspects are illustrative only and aspects thereof may be combined with aspects of other embodiments or teaching described herein, without limitation.

Aspect 1 is a method for loading vectorized data from a memory into GPRs of a GPU that includes receiving a load instruction for loading multiple data vectors from the memory into multiple GPRs for each of multiple fibers of the GPU, where the load instruction indicates a transposed load, and based on the load instruction indicating the transposed load, loading, for each data vector of the multiple data vectors, each element of the data vector to a GPR of multiple GPRs that is associated with a different one of the multiple fibers.

In Aspect 2, the method of Aspect 1 includes where the loading includes loading, for a first data vector of the multiple data vectors, each element of the first data vector to a first GPR associated with a different one of the multiple fibers, and loading, for a second data vector of the multiple data vectors, each element of the second data vector to a second GPR associated with a different one of the multiple fibers.

In Aspect 3, the method of Aspect 1 includes where the loading includes loading, for a first data vector of the multiple data vectors, a first element of the data vector to a first GPR associated with a first one of the multiple fibers, and a second element of the data vector to a second GPR associated with the first one of the multiple fibers, and loading, for a second data vector of the multiple data vectors, a first element of the second data vector to a first GPR associated with a second one of the multiple fibers, and a second element of the second data vector to a second GPR associated with the second one of the multiple fibers.

In Aspect 4, the method of Aspect 1 includes where the loading includes loading each element of each data vector such that each GPR with a common GPR index for each fiber of the multiple fibers includes one of the elements of a given one of the multiple data vectors.

In Aspect 5, the method of any of Aspects 1 to 4 includes where a texture or load store engine of the GPU performs the loading.

In Aspect 6, the method of any of Aspects 1 to 5 includes where a compiler of the GPU generates the load instruction to indicate performing the transposed load in an optimization process during compilation.

In Aspect 7, the method of any of Aspects 1 to 6 includes where the load instruction is a vec4 load instruction to load the multiple data vectors, each having four elements, into the multiple GPRs of four fibers of the GPU.

In Aspect 8, the method of any of Aspects 1 to 7 includes receiving a store instruction for storing data from the multiple GPRs for each of the multiple fibers into the memory, and based on the load instruction indicating a transposed load, or the store instruction indicating the transposed store, storing, in each data vector of the multiple data vectors, an element of the data from each GPR of multiple GPRs that is associated with a different one of the multiple fibers.

Aspect 9 is an apparatus including one or more processors, one or more memories coupled with the one or more processors, and instructions stored in the one or more memories and operable, when executed by the one or more processors, to cause the apparatus to perform any of the methods of Aspects 1 to 8.

Aspect 10 is an apparatus including means for performing any of the methods of Aspects 1 to 8.

Aspect 11 is one or more computer-readable media including code executable by one or more processors, the code including code for performing any of the methods of Aspects 1 to 8.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for loading vectorized data from a memory into general purpose registers (GPRs) of a graphics processing unit (GPU), comprising:
one or more processors including the GPU;
one or more memories coupled with the one or more processors; and
instructions stored in the one or more memories and operable, when executed by the one or more processors, to cause the apparatus to:
receive a load instruction for loading multiple data vectors from the memory into multiple GPRs for each of multiple fibers of the GPU, wherein the load instruction indicates a transposed load; and
based on the load instruction indicating the transposed load, load, for each data vector of the multiple data vectors, each element of the data vector to a GPR of multiple GPRs that is associated with a different one of the multiple fibers.

2. The apparatus of claim 1, wherein the instructions, when executed by the one or more processors, cause the apparatus to load including:
loading, for a first data vector of the multiple data vectors, each element of the first data vector to a first GPR associated with a different one of the multiple fibers; and
loading, for a second data vector of the multiple data vectors, each element of the second data vector to a second GPR associated with a different one of the multiple fibers.

3. The apparatus of claim 1, wherein the instructions, when executed by the one or more processors, cause the apparatus to load including:
loading, for a first data vector of the multiple data vectors, a first element of the data vector to a first GPR associated with a first one of the multiple fibers, and a second element of the data vector to a second GPR associated with the first one of the multiple fibers; and
loading, for a second data vector of the multiple data vectors, a first element of the second data vector to a first GPR associated with a second one of the multiple fibers, and a second element of the second data vector to a second GPR associated with the second one of the multiple fibers.

4. The apparatus of claim 1, wherein the instructions, when executed by the one or more processors, cause the apparatus to load including loading each element of each data vector such that each GPR with a common GPR index for each fiber of the multiple fibers includes one of the elements of a given one of the multiple data vectors.

5. The apparatus of claim 1, wherein a texture or load store engine of the GPU performs the loading.

6. The apparatus of claim 1, wherein a compiler of the GPU generates the load instruction to indicate performing the transposed load in an optimization process during compilation.

7. The apparatus of claim 1, wherein the load instruction is a vec4 load instruction to load the multiple data vectors, each having four elements, into the multiple GPRs of four fibers of the GPU.

8. The apparatus of claim 1, wherein the instructions, when executed by the one or more processors, cause the apparatus to:
receive a store instruction for storing data from the multiple GPRs for each of the multiple fibers into the memory; and
based on the load instruction indicating a transposed load, or the store instruction indicating the transposed store, store, in each data vector of the multiple data vectors, an element of the data from each GPR of multiple GPRs that is associated with a different one of the multiple fibers.

9. A computer-implemented method for loading vectorized data from a memory into general purpose registers (GPRs) of a graphics processing unit (GPU), comprising:
receiving a load instruction for loading multiple data vectors from the memory into multiple GPRs for each of multiple fibers of the GPU, wherein the load instruction indicates a transposed load; and
based on the load instruction indicating the transposed load, loading, for each data vector of the multiple data vectors, each element of the data vector to a GPR of multiple GPRs that is associated with a different one of the multiple fibers.

10. The computer-implemented method of claim 9, wherein the loading includes:
loading, for a first data vector of the multiple data vectors, each element of the first data vector to a first GPR associated with a different one of the multiple fibers; and
loading, for a second data vector of the multiple data vectors, each element of the second data vector to a second GPR associated with a different one of the multiple fibers.

11. The computer-implemented method of claim 9, wherein the loading includes:
loading, for a first data vector of the multiple data vectors, a first element of the data vector to a first GPR associated with a first one of the multiple fibers, and a second element of the data vector to a second GPR associated with the first one of the multiple fibers; and
loading, for a second data vector of the multiple data vectors, a first element of the second data vector to a first GPR associated with a second one of the multiple fibers, and a second element of the second data vector to a second GPR associated with the second one of the multiple fibers.

12. The computer-implemented method of claim 9, wherein the loading includes loading each element of each data vector such that each GPR with a common GPR index for each fiber of the multiple fibers includes one of the elements of a given one of the multiple data vectors.

13. The computer-implemented method of claim 9, wherein a texture or load store engine of the GPU performs the loading.

14. The computer-implemented method of claim 9, wherein a compiler of the GPU generates the load instruction to indicate performing the transposed load in an optimization process during compilation.

15. The computer-implemented method of claim 9, wherein the load instruction is a vec4 load instruction to load the multiple data vectors, each having four elements, into the multiple GPRs of four fibers of the GPU.

16. The computer-implemented method of claim 9, further comprising:
receiving a store instruction for storing data from the multiple GPRs for each of the multiple fibers into the memory; and
based on the load instruction indicating a transposed load, or the store instruction indicating the transposed store, storing, in each data vector of the multiple data vectors, an element of the data from each GPR of multiple GPRs that is associated with a different one of the multiple fibers.

17. A computer-readable medium, comprising code executable by one or more processors for loading vectorized data from a memory into general purpose registers (GPRs) of a graphics processing unit (GPU), the code comprising code for:
receiving a load instruction for loading multiple data vectors from the memory into multiple GPRs for each of multiple fibers of the GPU, wherein the load instruction indicates a transposed load; and
based on the load instruction indicating the transposed load, loading, for each data vector of the multiple data vectors, each element of the data vector to a GPR of multiple GPRs that is associated with a different one of the multiple fibers.

18. The computer-readable medium of claim 17, wherein the code for loading includes:
code for loading, for a first data vector of the multiple data vectors, each element of the first data vector to a first GPR associated with a different one of the multiple fibers; and
code for loading, for a second data vector of the multiple data vectors, each element of the second data vector to a second GPR associated with a different one of the multiple fibers.

19. The computer-readable medium of claim 17, wherein the code for loading includes:
code for loading, for a first data vector of the multiple data vectors, a first element of the data vector to a first GPR associated with a first one of the multiple fibers, and a second element of the data vector to a second GPR associated with the first one of the multiple fibers; and
code for loading, for a second data vector of the multiple data vectors, a first element of the second data vector to a first GPR associated with a second one of the multiple fibers, and a second element of the second data vector to a second GPR associated with the second one of the multiple fibers.

20. The computer-readable medium of claim 17, wherein the code for loading includes code for loading each element of each data vector such that each GPR with a common GPR index for each fiber of the multiple fibers includes one of the elements of a given one of the multiple data vectors.
